(19) United States
(12) Patent Application Publication
(10) Pub. No.: US 2026/0301422 A1
(43) Pub. Date: Oct. 1, 2026

(54) METHOD FOR DETECTING AND TRACKING OBJECTS IN THE SURROUNDINGS OF A VEHICLE

(71) Applicant: MERCEDES-BENZ GROUP AG, Stuttgart (DE)

(72) Inventors: Robin HEINZLER, Stuttgart (DE); Marvin SIMCHEN, Gerlingen (DE)

(21) Appl. No.: 19/477,975

(22) PCT Filed: Mar. 6, 2024
(86) PCT No.: PCT/EP2024/055769

§ 371 Date: Oct. 23, 2025

(30) Foreign Application Priority Data
Apr. 24, 2023 (DE) 10 2023 001 652.7

(51) Int. Cl. G06V 20/58; B60W 60/00

(52) U.S. Cl. CPC G06V 20/58; B60W 60/001

(57) ABSTRACT

Objects in the surroundings of a vehicle are detected and tracked using a lidar sensor that emits light signals in several consecutive measurements and detects reflections of the light signals returned by objects. A point cloud is generated for each measurement using the reflections and objects in the surroundings are detected and tracked using the point clouds generated in the consecutive measurements. Reflections of a measurement are compared to reflections of previous measurements, and reflections within a measurement that cannot be assigned to an object detected and tracked in the previous measurements are detected and filtered as surroundings influences not belonging to the object.

### BACKGROUND AND SUMMARY OF THE INVENTION

Exemplary embodiments of the invention relate to a method for detecting and tracking objects in the surroundings of a vehicle, as well as to a method for automatically operating a vehicle.

For automated, for example highly automated or autonomous, driving operation of a vehicle, the detection of the surroundings of the vehicle is necessary, which is performed by means of cameras, radar sensors, and lidar sensors. Here, lidar sensors measure their surroundings by emitting light signals in the infrared range and by detecting light signals reflected on objects. The data thus acquired by means of a lidar sensor can complete the detection of the surroundings in addition to data acquired by means of a camera and radar sensors and offer increased redundancy. Object detection algorithms based on lidar data process point clouds generated by means of lidar sensors, which represent raw data from lidar sensors, and detect objects based on points of these point clouds. Here, each point contains not only geometric coordinates, i.e., Cartesian or polar coordinates, but also further metadata about a lidar measurement, such as, for example, intensity, echo pulse width, and detection information. Based on geometric information of the point cloud, objects are detected by spatially nearby points being connected to form a continuous object.

Lidar sensors can be impaired in their perception and object detection by environmental influences such as dust, water vapor, or sand clouds. Conventional object algorithms, which detect objects based on a point cloud generated by means of a lidar sensor, can be impaired by such surroundings influences. Thus, objects can be incorrectly detected as false positive objects or with incorrect geometric dimensions. For example, if the lidar sensor detects an exhaust cloud of a vehicle, this can lead to the vehicle being incorrectly positioned or its geometric dimensions being incorrectly detected.

A method for controlling a vehicle is known from US 2019 179 052 A1. The method comprises the steps:
Receiving laser data acquired for the surroundings of the vehicle, wherein the laser data comprises several laser data points, in several scans;
Allocating laser data points to an object in the surroundings by a computing device;
Tracking the object in the surroundings as the vehicle moves through the surroundings, based on laser data that is received in the scans of the surroundings;
Determining given laser data points that are not linked to the object in the surroundings as representative of an untracked object;
Determining laser data points that are not linked to the object in the surroundings described by additional data;
Identifying, by the computing device, an indication of a weather condition in the surroundings based on laser data points that are not linked to the object in the environment; and
Controlling the vehicle in an autonomous mode based on the specification of the weather condition.

A method for estimating the self-motion of a vehicle is known from DE 10 2020 119 498 A1.

A method for optical distance measuring is known from EP 3 715 908 A1.

A method and a device for the surroundings detection with at least one lidar sensor is known from DE 10 2010 062 378 A1.

Exemplary embodiments of the invention are directed to a novel method for detecting and tracking objects in the surroundings of a vehicle and a novel method for automatically operating a vehicle.

In a method for detecting and tracking objects in the surroundings of a vehicle, light signals are emitted by means of at least one lidar sensor in several consecutive measurements, and reflections of the light signals returned by objects are recorded. By means of the reflections, a point cloud is generated for each measurement, and objects in the surroundings are detected and tracked by means of the point clouds generated in the consecutive measurements.

According to the invention, the reflections of a measurement are compared to reflections of previous measurements, and reflections within a measurement that cannot be assigned to an object detected and tracked in the previous measurements are detected and filtered as surroundings influences not belonging to the object.

During a measurement of a lidar sensor, i.e., the emission of a light signal and the detection of reflections associated with the object, further reflections may occur when they are caused by surroundings influences occurring between the lidar sensor and the tracked object, also referred to as the tracked object, such as rain, spray, exhaust fumes, dust, water vapor, sand clouds, and other influences. The method enables simple and reliable detection and filtering of these reflections associated with surroundings influences, so that the tracked object, and in particular its contours, can be reliably identified. In particular, surroundings influences that occur spontaneously, such as the drainage of liquid from the tracked object, can be identified by means of the method.

Thus, the present method enables the optimization of an object detection algorithm carried out by means of lidar data and an increase in the robustness thereof against surroundings influences. Thus, the detection of false-positive objects or incorrect geometric dimensions can be prevented.

According to a possible design of the method, reflections that cannot be assigned to an object detected and tracked in the previous measurements are used as reflections that influence a contour of an object detected and tracked in the previous measurements and/or generate a further object in the point clouds. This allows for particularly reliable detection of the surroundings influences and, consequently, particularly reliable filtering of such influences.

According to a further possible design of the method, the reflections that cannot be assigned to an object detected and tracked in the previous measurements are detected by means of secondary points in a point cloud, the secondary points being detected in a measurement between the emission of a light signal and the detection of reflections forming primary points that can be assigned to the object detected and tracked in the previous measurements. Such detection of surroundings influences can be carried out particularly simply and reliably.

According to the invention, in the method for generating a point cloud, a reflection curve is respectively formed, which represents a temporal course of the power of the reflections after the emission of a light signal. By means of an impulse length and/or an impulse height of reflections in the reflection curve, a distinction is made between reflections belonging to opaque objects and at least partially transparent objects, wherein the at least partially transparent objects are identified as surroundings influences not belonging to an opaque object detected and tracked in the previous measurements. This enables a reliable and easy-to-implement distinction between a tracked object and surroundings influences.

According to the invention, in the method, a temporal shift between at least two reflection curves recorded at different times is determined, wherein a one-dimensional determination of the respective speed of the reflections is performed by means of the recorded temporal shift. The determined speeds are assigned to the opaque objects and at least partially transparent objects, wherein the distinction between the opaque objects and at least partially transparent objects is verified by means of the assigned speeds. Such a verification can further increase the reliability of the distinction between a tracked object and surroundings influences.

According to a further possible design of the method, a temporal shift between at least two reflection curves recorded at different times is determined, wherein a one-dimensional determination of the respective speed of the reflections is carried out by means of the ascertained temporal shift. By means of a known transmission direction of the lidar sensor and the one-dimensionally determined speeds, three-dimensional speed vectors are respectively determined, wherein, by means of different magnitudes and directions of the speed vectors, a distinction is made between the object detected and tracked in the previous measurements and the surroundings influences. This also enables a reliable and easy-to-implement distinction between a tracked object and surroundings influences.

In a method for the automated, in particular highly automated or autonomous operation of a vehicle depending on data detected in a surroundings detection, a detection and tracking of objects in the surroundings of the vehicle is carried out in the surroundings detection by means of an aforementioned method.

By reliably distinguishing between tracked objects and surroundings influences, a degree of reliability of automated driving operation can be achieved, in particular the detection of false-positive objects or incorrect geometric dimensions can be prevented. A false-positively identified object can, for example, lead to incorrect braking or incorrect steering intervention, such that, by reliably preventing the detection of false-positive objects or incorrect geometric dimensions, incorrect maneuvers in the lateral and longitudinal direction of the vehicle can be avoided during automated driving operation.

Exemplary embodiments of the invention are explained in more detail below by means of drawings.

### BRIEF DESCRIPTION OF THE DRAWING FIGURES

Here are shown in:

FIG. 1, schematically, an image of the surroundings of a vehicle captured by means of a camera and a point cloud of these surroundings generated by means of a lidar sensor at a first point in time,

FIG. 2, schematically, an image of the surroundings of a vehicle captured by means of a camera, an enlarged section of the image and a point cloud of these surroundings generated by means of a lidar sensor at a second point in time,

FIG. 3, schematically, a point cloud of the surroundings of a vehicle at a point in time generated by means of a lidar sensor from secondary reflections and a point cloud of the surroundings of the vehicle at the same point in time generated by means of the lidar sensor from primary reflections,

FIG. 4, schematically, a vehicle with a lidar sensor during a detection of the surroundings of the vehicle, and

FIG. 5, schematically, a reflection curve, which represents a temporal course of the power of reflections detected by means of a lidar sensor after a light signal has been emitted.

Parts corresponding to one another are provided with the same reference number in all figures.

### DETAILED DESCRIPTION

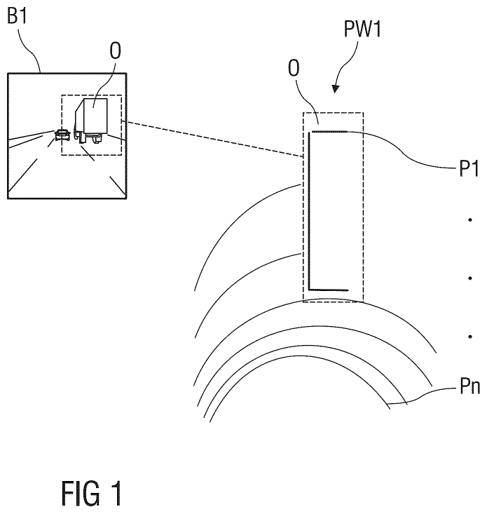

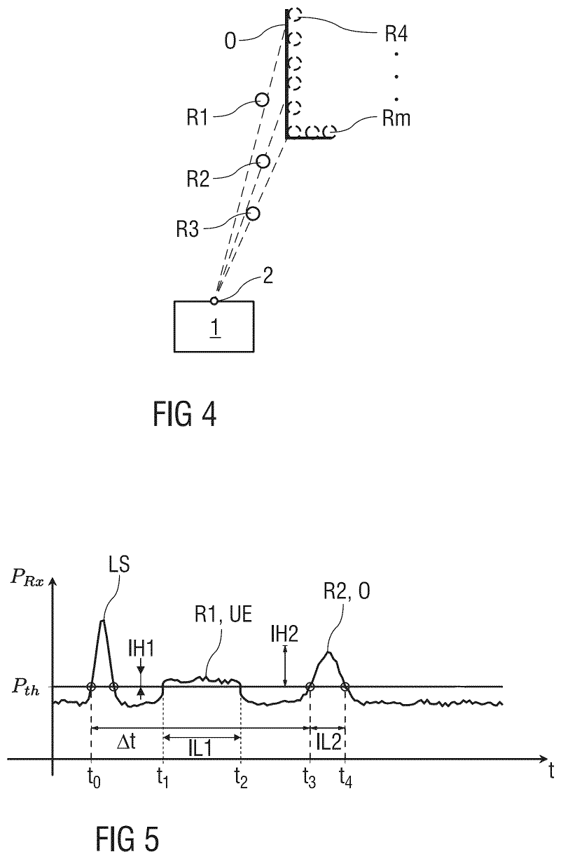

In FIG. 1, an image B1 of the surroundings of a vehicle 1 shown in FIG. 4, captured by means of a camera, and a point cloud PW1 of these surroundings, generated by means of a lidar sensor 2, also shown in FIG. 4, at a first point in time are depicted. Here, the point cloud PW1 shows the surroundings depicted in the image B1 from a top view or bird's eye view. Here, the image B1 shows several objects, wherein only one object O is considered for clarity and to simplify the description.

To detect and track objects O in the surroundings of a vehicle 1, light signals LS, depicted in more detail in FIG. 5, are emitted by means of at least one lidar sensor 2 in several consecutive measurements, and reflections R1 to Rm of the light signals LS, which are returned by objects O and depicted in more detail in FIG. 4, are recorded. By means of the reflections R1 to Rm, a point cloud PW1 is generated for each measurement, and by means of the point clouds PW1 generated in the consecutive measurements, objects O in the surroundings are detected by means of a detection algorithm and tracked by means of a tracking algorithm.

The object O depicted is such an object O that has already been tracked over several measurements, which is located in a right-hand adjacent lane in front of the vehicle 1 and whose left and rear contour, detected by means of the lidar sensor 2, is depicted in the point cloud PW1 in a substantially L-shaped manner.

Here, the points P1 to Pn forming the point cloud PW1 are based on recorded primary reflections R1 to Rm and secondary reflections R1 to Rm. This results from the fact that lidar sensors 2 detect multiple detections or reflections R1 to Rm per emitted light signal LS. These detections are sorted, for example, according to their distance from the lidar sensor 2 and named, for example, first and second echo or primary and secondary reflections R1 to Rm. Here, the first echo or the primary reflection R1 to Rm has a greater radial distance from the lidar sensor 2 than the second echo or the secondary reflection R1 to Rm.

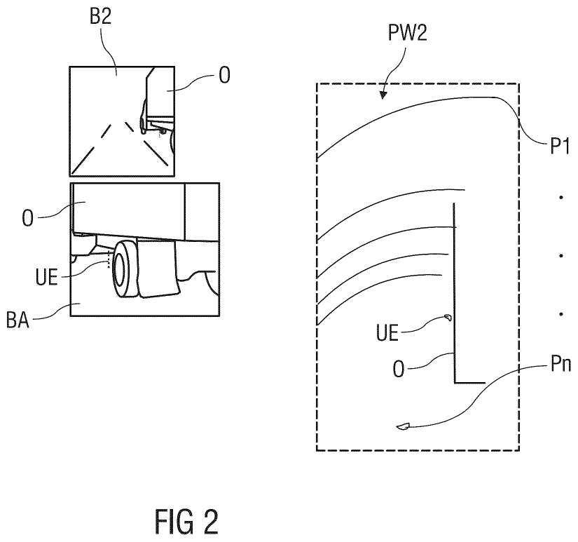

FIG. 2 shows an image B2 of the surroundings of the vehicle 1 captured by means of a camera at a second point in time later in comparison to in FIG. 1, an enlarged section BA of the image B2 and a point cloud PW2 of these surroundings generated by means of the lidar sensor 2 at this second point in time.

As the image section BA shows, at this second point in time, the object O, in the form of a truck, emits condensate, which is represented in the point cloud PW2 by points P1 to Pn located to the left of the contour of object O. Since this condensate does not belong to the tracked object O, it is referred to below as surroundings influence UE.

Such surroundings influences UE, which are also formed by rain, spray, exhaust gases, dust, water vapor, sand clouds, and other influences, can impair the detection and tracking of objects O in the surroundings of the vehicle 1 carried out by evaluating the point clouds PW1, PW2.

In order to avoid such impairments, it is provided that the reflections R1 to Rm of a measurement, for example the measurement according to FIG. 2, and a resulting point cloud PW2 are compared to reflections R1 to Rm of previous measurements, for example the measurement according to FIG. 1, and a resulting point cloud PW1, wherein reflections R1 to Rm within a measurement which cannot be assigned to an object O detected and tracked in the previous measurements are detected and filtered as surroundings influences UE not belonging to the object O.

Such reflections R1 to Rm that cannot be assigned to the object O are represented, for example, by the points P1 to Pn caused by the condensate in the point cloud PW2, which are located to the left of the contour of the object O and thus influence the contour of the object O detected and tracked in the previous measurements and/or generate a further object in the point cloud PW2.

The detection of such reflections R1 to Rm can be carried out, for example, by detecting secondary points P1 to Pn generated by said secondary reflections R1 to Rm in the point cloud PW2, which are detected in a measurement between the emission of a light signal LS and a detection of reflections R1 to Rm forming primary points P1 to Pn, which can be assigned to the object O detected and tracked in the previous measurements.

As depicted, the object O is an object O tracked over several time cycles or measurements. If detections occur below with several secondary reflections R1 to Rm that influence the contour-defining shape of the object O or cause a further object, the use of secondary reflections R1 to Rm can be excluded for the detection of the object O. Thus, the geometric properties of the object O in the lidar measurement are stabilized and the detection of a false-positive object geometry can be prevented. If an object detected in the lidar measurement consists primarily of secondary reflections R1 to Rm or secondary points P1 to Pn, it is very likely that there is a surroundings influence UE. Information about this can be passed on to downstream algorithms in order to prevent the detection of false-positive objects or false-positive object geometries.

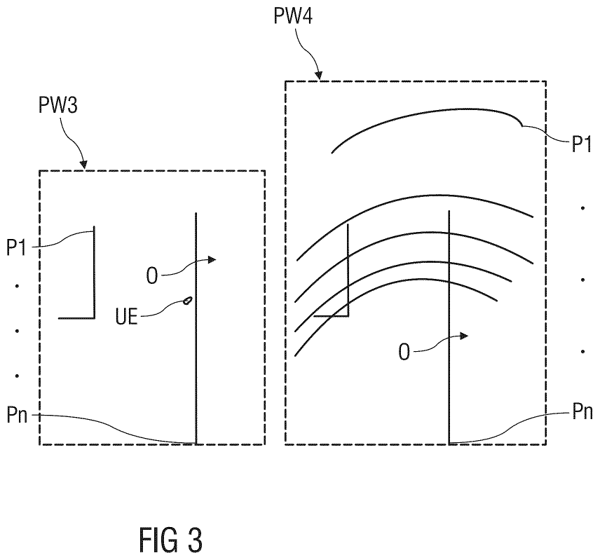

In order to illustrate this, FIG. 3 shows a point cloud PW3 of the surroundings of a vehicle 1 at a point in time, generated by means of a lidar sensor 2 from secondary reflections R1 to Rm, and a point cloud PW4 of the surroundings of the vehicle 1 at the same point in time, generated by means of the lidar sensor 2 from primary reflections R1 to Rm.

By distinguishing the two point clouds PW3 and PW4, it becomes clear that the previously smoothly tracked contour of object O formed as a truck is still detected via the primary points P1 to Pn formed from primary reflections R1 to Rm. If the primary points P1 to Pn formed from secondary reflections R1 to Rm are not used for object formation, then the surroundings influences UE, such as the condensate in this example, can be ignored.

Thus, object detection can be realized that is robust against surroundings influences UE by the secondary reflections R1 to Rm for object formation being excluded.

FIG. 4 shows a vehicle 1 with a lidar sensor 2 during a detection of the surroundings of the vehicle 1.

In the detection range of the lidar sensor 2, there is an object O to the right in front of the vehicle 1, for example a truck according to FIGS. 1 and 2.

The detection of secondary reflections R1 to R3 and primary reflections R4 to Rm can be carried out, for example, by evaluating a reflection curve shown in more detail in FIG. 5. Here, secondary reflections R1 to R3 are characterized in that, after them, further primary reflections R4 to Rm are detected in the temporal course of the backscatter curve. Thus, the secondary echo is at least partially transparent.

Primary reflections R4 to Rm are characterized in that, between an emitted light signal LS, for example a light impulse, and the detected primary reflection R4 to Rm, further reflections R1 to Rm, for example, the secondary reflections R1 to R3, have been detected.

The reflection curve of FIG. 5 depicts a course of a power P_{Rx} of reflections R1 to Rm detected by a lidar sensor 2 after a light signal LS has been emitted depending on the time t.

If a lidar sensor 2 records the entire reflection curve over the temporal course, then in addition to the detection of objects O by means of the characteristic reflection curve, an extraction of the properties of the detected objects O is possible. For example, a distinction between solid and partially transparent objects O is thus possible using an impulse length IL1, IL2 and impulse height IH1, IH2.

According to the reflection curve depicted, a light signal LS is emitted as a light impulse at a point in time t₀. Between a point in time t₁ and a further point in time t₂, a detection of a first reflection R1 is carried out with a relatively long impulse length IL1 and a relatively short impulse height IH1, which emerges between amplitudes of the reflection R1 and a predetermined power threshold P_{th.}

Between a point in time t₃ and a point in time t₄, detection of a further reflection R2 is carried out with a relatively short impulse length IL2 and a relatively large impulse height IH2, which emerges between amplitudes of the reflection R2 and the predetermined power threshold Pₜₕ. After the point in time t₄, the detected signal is characterized by noise.

Here, it can be seen that the reflection R2, recorded temporally after the reflection R1, with a comparatively short impulse length IL2 and a large impulse height IH2, is a primary reflection R2 of a tracked opaque object O, and the reflection R1, with a comparatively long impulse length IL1 and a low impulse height IH1, is a secondary reflection R1 of an at least partially transparent surroundings influence UE, for example, dust. Thus, by means of the impulse length IL1, IL2 and impulse height IH1, IH2, a distinction can be made between solid or opaque objects and at least partially transparently formed objects.

Furthermore, it is possible to determine a one-dimensional speed of the recorded reflections R1 to Rm based on a temporal shift of the two measurements by means of reflection curves of two measurements which have been recorded at different points in time. The characteristics of the reflection curves then allow the different reflections R1 to Rm to be assigned. Furthermore, three-dimensional speed vectors can be determined using a known transmission direction of the lidar sensor 2. Thus, the described objects O and surroundings influences UE can be separated based on the different magnitudes and directions of the speed vectors.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

1-5. (canceled)

6. A method for detecting and tracking objects in surroundings of a vehicle, the method comprising:
emitting, using a lidar sensor of the vehicle, light signals in several consecutive measurements;
detecting, by the lidar sensor, reflections of the light signals in the several consecutive measurements;
generating, using the reflections, a point cloud for each measurement of the several consecutive measurements;
detecting and tracking at least one object in the point cloud for each measurement of the several consecutive measurements;
comparing the reflections of one of the several consecutive measurements to a previous one of the several consecutive measurements;
determining that reflections within the one of the several consecutive measurements that cannot be assigned to the at least one object in the previous one of the several consecutive measurements does not belong to the at least one object; and
filtering the reflections within the one of the several consecutive measurements that cannot be assigned to the at least one object in the previous one of the several consecutive measurements as surroundings influences,
wherein the generation of the point cloud for each measurement comprises
forming a reflection curve depicting a temporal course of a power of the reflections after the emitting of the light signal;
distinguishing, using an impulse length of the reflections in the reflection curve or an impulse height of the reflections in the reflection curve, between reflections belonging to opaque objects belong to at least partially transparent objects;
detecting the at least partially transparent objects as surroundings influences not belonging to an opaque object detected and tracked in previous measurements of the several consecutive measurements;
determining a temporal shift between at least two reflection curves recorded at different points in time;
determining, using the determined temporal shift, a one-dimensional speed of the reflections;
allocating the determined speeds to the opaque objects and at least partially transparent objects; and
verifying, using the allocated speeds, the distinguishing between the opaque objects and the at least partially transparent objects.

7. The method of claim 6, wherein reflections not assigned to an object detected and tracked in the previous measurements of the several consecutive measurements are used that influence a contour of an object detected and tracked in the previous measurements of the several consecutive measurements or to generate a further object in the point clouds.

8. The method of claim 6, wherein reflections that cannot be assigned to an object detected and tracked in the previous measurements of the several consecutive measurements are detected using secondary points in a point cloud that are detected in a measurement between emission of a light signal and a detection of reflections forming primary points and are assignable to the object detected and tracked in the previous measurements of the several consecutive measurements.

9. The method of claim 6, further comprising:
determining a temporal shift between at least two reflection curves recorded at different points in time;
determining, using the determined temporal shift, a one-dimensional respective speed of the reflections;
respectively determining three-dimensional speed vectors based on a known transmission direction of the lidar sensor and the determined one-dimensional speeds; and
distinguishing between the object detected and tracked in the previous measurements of the several consecutive measurements and the surroundings influences by using different magnitudes and directions of the speed vectors.

10. A method for automatically operating a vehicle, the method comprising:
emitting, using a lidar sensor of the vehicle, light signals in several consecutive measurements;
detecting, by the lidar sensor, reflections of the light signals in the several consecutive measurements;
generating, using the reflections, a point cloud for each measurement of the several consecutive measurements;
detecting and tracking at least one object in the point cloud for each measurement of the several consecutive measurements;
comparing the reflections of one of the several consecutive measurements to a previous one of the several consecutive measurements;
determining that reflections within the one of the several consecutive measurements that cannot be assigned to the at least one object in the previous one of the several consecutive measurements does not belong to the at least one object; and
filtering the reflections within the one of the several consecutive measurements that cannot be assigned to the at least one object in the previous one of the several consecutive measurements as surroundings influences; and
autonomously operating the vehicle based on the reflections from the several consecutive measurements,
wherein the generation of the point cloud for each measurement comprises
forming a reflection curve depicting a temporal course of a power of the reflections after the emitting of the light signal;
distinguishing, using an impulse length of the reflections in the reflection curve or an impulse height of the reflections in the reflection curve, between reflections belonging to opaque objects belong to at least partially transparent objects;
detecting the at least partially transparent objects as surroundings influences not belonging to an opaque object detected and tracked in previous measurements of the several consecutive measurements;
determining a temporal shift between at least two reflection curves recorded at different points in time;
determining, using the determined temporal shift, a one-dimensional speed of the reflections;
allocating the determined speeds to the opaque objects and at least partially transparent objects; and
verifying, using the allocated speeds, the distinguishing between the opaque objects and the at least partially transparent objects.
